(19) United States
(12) Patent Application Publication
(10) Pub. No.: US 2008/0293331 A1
(43) Pub. Date: Nov. 27, 2008

(54) METHODS AND APPARATUS FOR LOW COST AND HIGH PERFORMANCE POLISHING TAPE FOR SUBSTRATE BEVEL AND EDGE POLISHING IN SEMINCONDUCTOR MANUFACTURING

(75) Inventors: Yufei Chen, San Jose, CA (US); Zhenhua Zhang, San Jose, CA (US); Sen-Hou Ko, Sunnyvale, CA (US); Wei-Yung Hsu, Santa Clara, CA (US); Makoto Matsuo, Sunnyvale, CA (US)

Correspondence Address: DUGAN & DUGAN, PC, 245 Saw Mill River Road, Suite 309, Hawthorne, NY, 10532, US

(73) Assignee: Applied Materials, Inc., Santa Clara, CA (US)

(21) Appl. No.: 12/124,153

(22) Filed: May 21, 2008

Related U.S. Application Data
(60) Provisional application No. 60/939,337, filed on May 21, 2007.
(60) Provisional application No. 61/046,452, filed on Apr. 21, 2008.

(51) Int. Cl. B24B 9/06; C08J 5/14

(52) U.S. Cl. 451/37; 451/324; 51/298; 51/295; 51/307; 451/44

(57) ABSTRACT

Apparatus and methods are provided relating to polishing a substrate using a polishing device, such as a polishing tape. The polishing device may be formed to include a base, a resin layer adhering to the base, and a plurality of embossed abrasive particles and/or abrasive beads affixed to the base by the resin layer. The plurality of abrasive particles and/or beads may be embossed in the resin layer. The plurality of abrasive beads may include a plurality of abrasive particles suspended in binder material. The plurality of abrasive particles and/or beads and the resin layer combine to form an abrasive side of the polishing device adapted to contact the substrate. Polishing of the substrate preferably includes polishing an edge of the substrate while the substrate is rotated by a holding device such that no apparatus other than the polishing tape contacts the edge while the substrate is rotating.

### CROSS-REFERENCE TO RELATED APPLICATIONS

The present application claims priority to U.S. Patent Application Ser. No. 60/939,337 filed May 21, 2007, titled “METHODS AND APPARATUS FOR HIGH PERFORMANCE SUBSTRATE BEVEL AND EDGE POLISHING IN SEMICONDUCTOR MANUFACTURE” (Attorney Docket No. 11809/L), and to U.S. Patent Application Ser. No. 61/046,452 filed Apr. 21, 2008, titled “METHODS AND APPARATUS FOR LOW COST AND HIGH PERFORMANCE SUBSTRATE BEVEL AND EDGE POLISHING IN SEMICONDUCTOR MANUFACTURE” (Attorney Docket No. 13398/L), each of which is hereby incorporated herein by reference in its entirety for all purposes.

The present application is also related to the following commonly-assigned, co-pending U.S. Patent Applications, each of which is hereby incorporated herein by reference in its entirety for all purposes:

U.S. patent application Ser. No. 11/299,295 filed on Dec. 9, 2005 and titled “METHODS AND APPARATUS FOR PROCESSING A SUBSTRATE” (Attorney Docket No. 10121);

U.S. patent application Ser. No. 11/298,555 filed on Dec. 9, 2005 and titled “METHODS AND APPARATUS FOR PROCESSING A SUBSTRATE” (Attorney Docket No. 10414);

U.S. patent application Ser. No. 11/693,695 filed on Mar. 29, 2007 and titled “METHODS AND APPARATUS FOR POLISHING AN EDGE OF A SUBSTRATE” (Attorney Docket No. 10560);

U.S. Patent Application Ser. No. 60/939,351 filed May 21, 2007, titled “METHODS AND APPARATUS FOR POLISHING A NOTCH OF A SUBSTRATE USING AN INFLATABLE POLISHING WHEEL” (Attorney Docket No. 10674/L);

U.S. Patent Application Ser. No. 60/939,353 filed May 21, 2007, titled “METHODS AND APPARATUS FOR FINDING A SUBSTRATE NOTCH CENTER” (Attorney Docket No. 11244/L);

U.S. Patent Application Ser. No. 60/939,343 filed May 21, 2007, titled “METHODS AND APPARATUS TO CONTROL SUBSTRATE BEVEL AND EDGE POLISHING PROFILES OF EPITAXIAL FILMS” (Attorney Docket No. 11417/L);

U.S. Patent Application Ser. No. 60/939,219 filed May 21, 2007, titled “METHODS AND APPARATUS FOR POLISHING A NOTCH OF A SUBSTRATE USING A SHAPED BACKING PAD” (Attorney Docket No. 11483/L);

U.S. Patent Application Ser. No. 60/939,342 filed May 21, 2007, titled “METHODS AND APPARATUS FOR REMOVAL OF FILMS AND FLAKES FROM THE EDGE OF BOTH SIDES OF A SUBSTRATE USING BACKING PADS” (Attorney Docket No. 11564/L);

U.S. Patent Application Ser. No. 60/939,350 filed May 21, 2007, titled “METHODS AND APPARATUS FOR USING A BEVEL POLISHING HEAD WITH AN EFFICIENT TAPE ROUTING ARRANGEMENT” (Attorney Docket No. 11565/L);

U.S. Patent Application Ser. No. 60/939,344 filed May 21, 2007, titled “METHODS AND APPARATUS FOR USING A ROLLING BACKING PAD FOR SUBSTRATE POLISHING” (Attorney Docket No. 11566/L);

U.S. Patent Application Ser. No. 60/939,333 filed May 21, 2007, titled “METHODS AND APPARATUS FOR SUBSTRATE EDGE POLISHING USING A POLISHING ARM” (Attorney Docket No. 11567/L);

U.S. Patent Application Ser. No. 60/939,212 filed May 21, 2007, titled “METHODS AND APPARATUS FOR IDENTIFYING A SUBSTRATE EDGE PROFILE AND ADJUSTING THE PROCESSING OF THE SUBSTRATE ACCORDING TO THE IDENTIFIED EDGE PROFILE” (Attorney Docket No. 11695/L);

U.S. Patent Application Ser. No. 60/939,228 filed May 21, 2007, titled “METHODS AND APPARATUS FOR POLISHING A NOTCH OF A SUBSTRATE BY SUBSTRATE VIBRATION” (Attorney Docket No. 11952/L); and

U.S. Patent Application Ser. No. 60/939,209 filed May 21, 2007, titled “METHODS AND APPARATUS FOR CONTROLLING THE SIZE OF AN EDGE EXCLUSION ZONE OF A SUBSTRATE” (Attorney Docket No. 11987/L).

### FIELD OF THE INVENTION

The present invention relates generally to substrate processing, and more particularly to methods and apparatus related to polishing tape for cleaning an edge of a substrate.

### BACKGROUND OF THE INVENTION

Substrates are used in semiconductor device manufacturing. During processing, the edge of the substrate may become dirty, which may negatively affect the semiconductor devices. To clean the edge of the substrate, conventional systems contact the substrate edge with an abrasive film or polishing tape. Process parameters, such as down force, velocity, and consumables determine the rate at which the polishing tape removes oxide and nitride from the wafer edge and bevel. The down force and velocity are limited in their process performance roles. The consumables, including polishing tapes and chemicals, therefore play an important role in enhancing the polishing removal rate.

The conventional polishing tape includes large size diamond tape. While use of large size diamond tape increases removal rates compared to other tapes, it also results in a poor surface finish requiring subsequent buffing steps. Accordingly, improved methods and apparatus related to low cost, high performance polishing tape for cleaning an edge of a substrate are desired.

### SUMMARY OF THE INVENTION

The present invention is defined by the following claims, and nothing in this section should be taken as a limitation on those claims.

The invention relates to methods and apparatus adapted to polish a substrate using a polishing device. The polishing device may include a polishing tape, a polishing pad or a polishing tip. The polishing device may be formed to include a base having a first surface, a resin layer adhering to the first surface of the base, and a plurality of embossed abrasive particles and/or abrasive beads affixed to the first surface by the resin layer. The plurality of abrasive particles and/or beads may be embossed on the first surface. The plurality of abrasive beads may include a plurality of abrasive particles suspended in binder material. The plurality of abrasive particles and/or beads and the resin layer combine to form an abrasive side of the polishing device adapted to contact the substrate. Polishing of the substrate preferably includes polishing an edge of the substrate while the substrate is rotated by a holding device such that no apparatus other than the polishing tape contacts the edge while the substrate is rotating.

Other features and aspects of the present invention will become more fully apparent from the following detailed description, the appended claims and the accompanying drawings.

### BRIEF DESCRIPTION OF THE DRAWINGS

FIG. 1A is a schematic illustration of a cross-section of a portion of a substrate, whereas FIG. 1B is a plan view of a substrate having an exaggerated notch portion.

FIGS. 2A and 2B are perspective views depicting exemplary embodiments of edge cleaning systems according to the present invention.

FIG. 3 is a plan view depicting another exemplary embodiment of an edge cleaning system according to the present invention.

FIGS. 4A and 4B are schematic perspective illustrations depicting exemplary embodiments of a polishing tape roll.

FIG. 5 is a graphic illustration comparing oxide removal rate data from polishing tapes of different types.

FIG. 6 is a schematic elevation illustration depicting an example embodiment of a polishing tape polishing an edge of a substrate.

FIG. 7 is a graphic illustration comparing process performance data from polishing at different tape speeds.

FIG. 8A is a schematic plan illustration depicting an example embodiment of an edge cleaning apparatus according to the present invention. FIG. 8B graphically compares removal rates of three edge polishing processes. FIGS. 8C and 8D represent surface finishes of two polishing processes.

FIG. 9 is a flowchart depicting an exemplary process of application of a polishing tape to an edge of a substrate.

### DETAILED DESCRIPTION

### Substrates

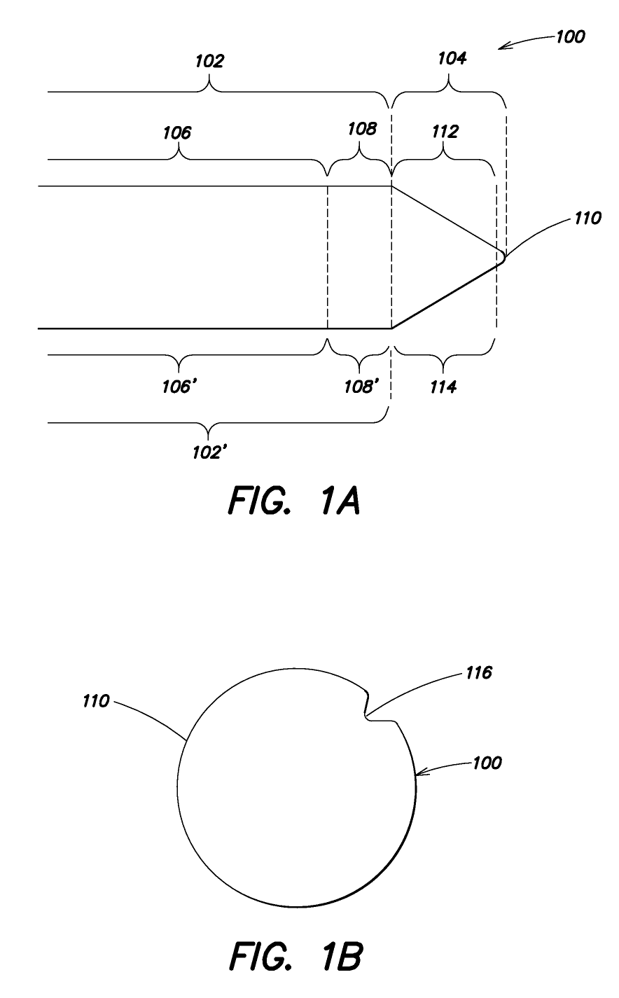

The present invention provides improved methods and apparatus for low cost, high performance polishing tape for cleaning and/or polishing a target surface, such as an edge of a substrate. With reference to FIG. 1A, a substrate 100 may include two major surfaces 102, 102′ and an edge 104. Each major surface 102, 102′ of the substrate 100 may include a device region 106, 106′ and an exclusion region 108, 108′. Typically however, only one of the two major surfaces 102, 102′ will include a device region and an exclusion region. Major surface 102 may be considered a top surface and include the device region 106 and the exclusion region 108, whereas major surface 102′ may be considered a back surface, with device region 106′ and exclusion 108′ being optional. The exclusion regions 108, 108′ may serve as buffers between the device regions 106, 106′ and the edge 104. The edge 104 of a substrate 100 may include an outer edge 110 and bevels 112, 114. Bevel 112 may be considered an upper bevel, whereas bevel 114 may be considered a lower bevel. Outer edge 110 may be considered an edge crown. The bevels 112, 114 may be located between the outer edge 110 and the exclusion regions 108, 108′ of the two major surfaces 102, 102′.

As shown in FIG. 1B, the substrate 100 may include a notch 116 along the outer edge 110. The notch 116 may used for positioning purposes during manufacturing of the semiconductor devices on the substrate 100. The notch 116 in FIG. 1B is depicted much larger relative to the substrate 100 than in reality for purposes of illustration. The present invention may be adapted to clean and/or polish the outer edge 110 and at least one bevel 112, 114 of a substrate 100 without affecting the device regions 106, 106′. In some embodiments, all or part of the exclusion regions 108, 108′ and/or notch 116 may be cleaned or polished as well.

### Polishing Systems

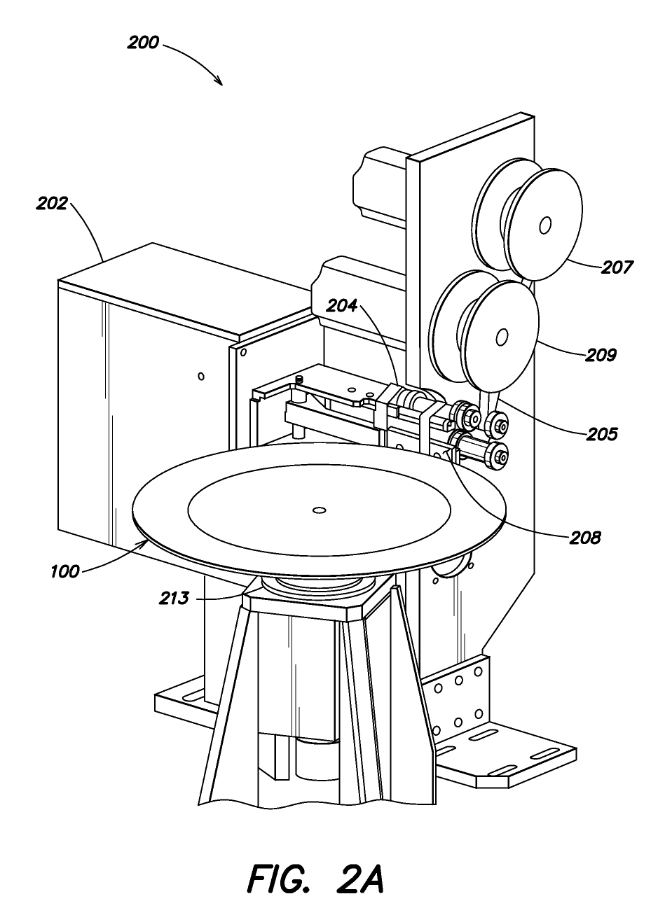

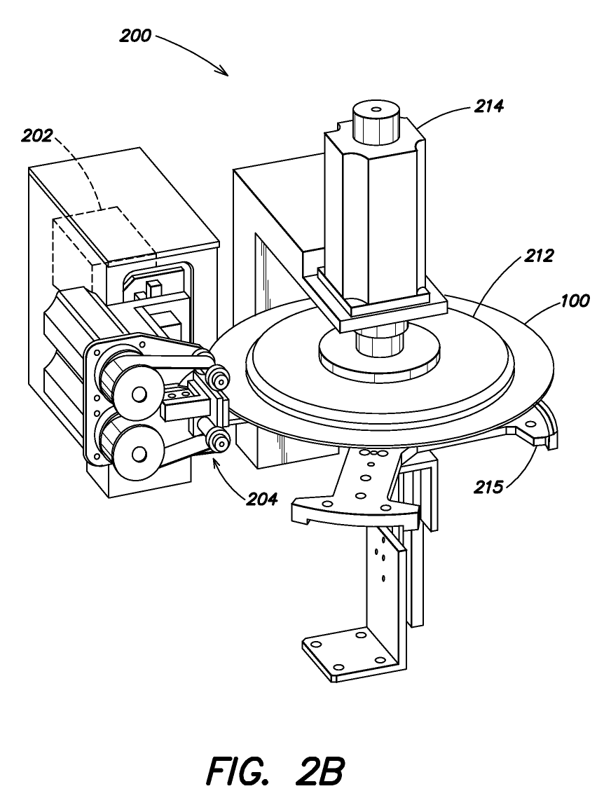

Referring to FIGS. 2A and 2B, perspective views of different exemplary edge polishing systems 200 are depicted from differing angles. In the system 200 of FIG. 2A, the substrate device surface typically is facing upward, whereas in the system 200 of FIG. 2B, the substrate device surface typically is facing downward. As shown in FIG. 2A, an exemplary edge polishing system 200 may include a base or frame 202 that includes a head 204 which supports polishing tape 205 tensioned between spools 207, 209 and further supported by a pad 208. The frame 202 may include a head rotator that rotates the head 204, as shown in FIG. 2B. As shown, the pad 208 may be mounted to the head 204 via an actuator (e.g., a pneumatic slide, hydraulic ram, servo motor driven pusher, etc.).

The actuator may be adapted to adjustably press and contour the tape 205 against a substrate edge 104. Alternatively, the actuator may be used to push the pad 208 against the tape 205 or to push the entire head 204 toward the substrate 100. Alternatively, the pad 208 may be mounted to the head 204 via a biasing device such as a spring. The biasing device may provide flexible/dynamic counter-pressure to the pad 208. The frame 202 (that includes head 204) may be adapted to be angularly translated, relative to an axis that is tangential to the edge 104 of a substrate 100 held in the system 200. The edge polishing system 200 of FIG. 2B, slightly different than that of FIG. 2A, also depicts a vacuum chuck 212 coupled to a driver 213 (e.g., motor, gear, belt, chain, etc.). The vacuum chuck 212 also may be connected to a wafer spinner 214, as shown in FIG. 2B. The driver 213 or other equipment may be supported by a pedestal 215.

Unlike some embodiments that may include one or more drive rollers (not shown) and guide rollers (not shown) that are adapted to rotate the edge 104 of the substrate 100 against the polishing tape 205, an advantage of an embodiment using a holding device, such as a vacuum chuck, to rotate the substrate is that the system 200 does not need to contact the edge 104 being polished. In other words, the polishing tape is the only apparatus in contact with the edge while the substrate is rotating. Fluids, as discussed, below, nonetheless may contact the edge during rotation, but fluids are not considered apparatus in this context. Thus, the potential of particles accumulating on drive rollers and being re-deposited on the edge 104 is eliminated. The need to clean rollers also is eliminated. Further, the possibility of rollers damaging or scratching the edge is also eliminated. By holding the substrate in a vacuum chuck, high speed rotation without significant vibration may be achieved.

Additionally, the spools 207, 209 that are mounted to the head 204, may be driven by one or more drivers (not shown) (e.g. servo-motors). The drivers may provide both an indexing capability to allow a specific amount of unused tape 205 to be advanced or continuously fed to the substrate edge, and a tensioning capability to allow the polishing film to be stretched taught and to apply pressure to the substrate edge.

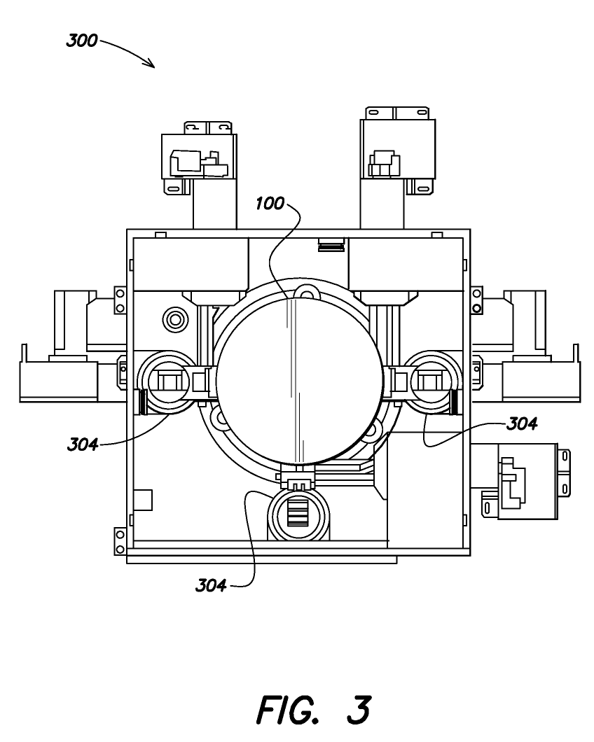

FIG. 3 is a plan view depicting another example embodiment of an edge cleaning system 300 according to the present invention. FIG. 3 depicts an edge polishing system 300 including three heads 304. Substrate edge/notch polishing may be performed using one or more polishing apparatus, e.g., head 304. As suggested by FIGS. 2A, 2B and 3, any number and type of heads 204, 304 may be used in any practicable combination. In one or more embodiments, e.g., system 300, a plurality of polishing apparatus may be employed, in which each polishing apparatus may have similar or different characteristics and/or mechanisms. In addition, in such multi-head embodiments, each head 204 and 304 may use a differently configured or type of polishing tape 205 (e.g., different grits, materials, tensions, pressures, etc.). Any number of heads 204 and 304 may be used concurrently, individually, and/or in a sequence. Different heads 204 and 304 may be used for different substrates 100 or different types of substrates.

Particular polishing apparatus may be employed for specific operations and/or purposes. For example, one or more of a plurality of polishing apparatus may be adapted to perform relatively rough polishing and/or adjustments while another one or more of the plurality of polishing apparatus may be adapted to perform relatively fine polishing and/or adjustments. Polishing apparatus may be used in sequence so that, for example, a rough polishing procedure may be performed initially, and a fine polishing procedure may be employed subsequently to make adjustments to a relatively rough polish as needed or according to a polishing recipe. The plurality of polishing apparatus may be located in a single chamber or module, or alternatively, one or more polishing apparatus may be located in separate chambers or modules. Where multiple chambers are employed, a robot or another type of transfer mechanism may be employed to move substrates between the chambers so that polishing apparatus in the separate chambers may be used in series or otherwise.

### Polishing Tape

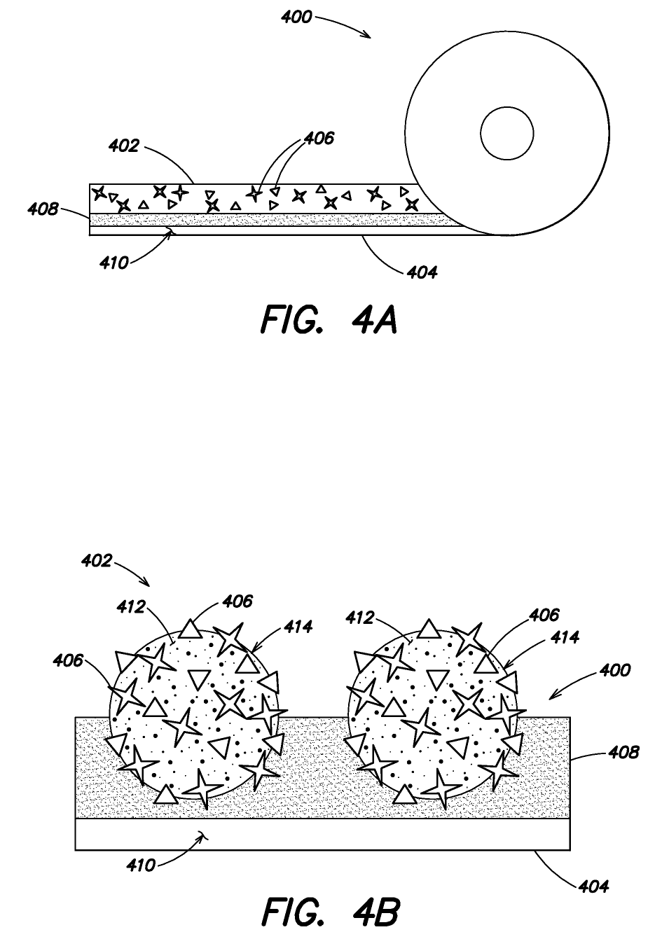

Turning to FIG. 4A, the present invention provides an abrasive polishing tape 400 for polishing the edge 104 of the substrate 100 as the substrate 100 is rotated (e.g., by a vacuum chuck 212, driver rollers, etc.). The tape 400 may be pressed against the rotating substrate edge 104. The tape 400 has an abrasive side 402 and a non-abrasive, e.g., smooth side 404, forming opposing sides of a tape base 410. Tape base 410 typically is a planar strip or sheet of material, such as a polymer film, generally having a first surface and a second surface, where the first surface becomes the abrasive side 402 and the second surface serves as the non-abrasive side 404. The polishing tapes 400 used in the substrate edge polish may be composed of various abrasive materials and coated on the tape base 410, e.g., a polymer film, such as polyethylene terephthalate (PET). The abrasive side 402 may be formed from a plurality of abrasive particles 406 being embedded in a resin layer 408 on the abrasive side 402 of the base 410.

### Polishing Abrasives

The plurality of abrasive particles 406 may be formed from minerals of ceria, silica and/or diamond, or any other suitable minerals or materials. In some embodiments, the abrasive particles 406 may range from about 0.5 microns up to about 3 microns in size, although other sizes may be used. Material removal by the fixed abrasive tape 400 increases, in general, with the size of the abrasive particles 406. However, larger particle sizes will increase the surface roughness, which might impact the process performance.

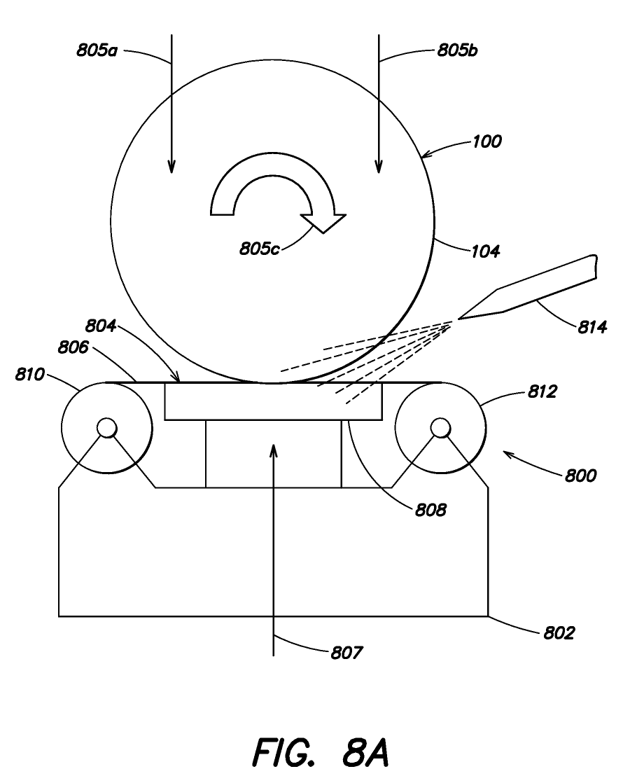

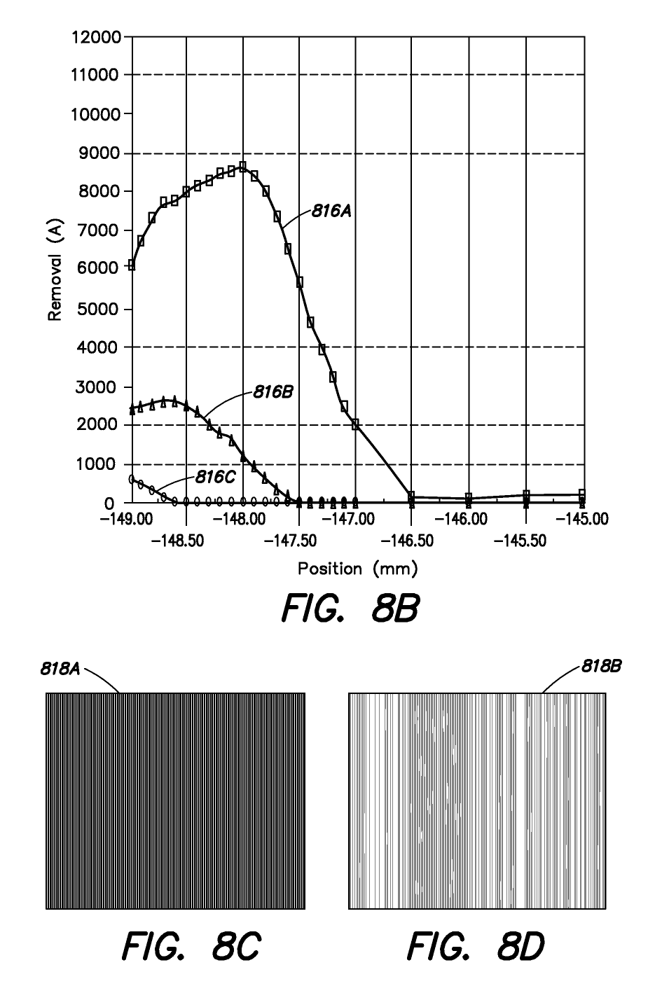

In accordance with the present invention, the abrasive particles may be embossed on the tape base 410, shown in FIG. 4A. Embossed particles are characterized as partially raised above the top surface of the resin and partially sunken in the resin. An embossed fixed abrasive tape preferably may be used in a chemical environment to obtain a higher polish rate than that of a diamond tape, while maintaining a good surface finish and avoiding the need for a buffing step. In the context of semiconductor fabrication, chemical mechanical planarization (CMP) of the substrate surface 102 involves use of a fixed abrasive polishing pad in conjunction with a chemical slurry. An exemplary CMP process would be the STI process of Applied Materials Inc. By analogy, a novel CMP-style polishing process may be applied to the edge 104 using such CMP-polishing-pad-type materials in a roll form with a spray of chemical slurry, as depicted in FIG. 8A. Selection of the chemicals occurs in accordance with selection of the resin and tape base to ensure compatibility and to enhance removal capability as well as provide better surface finish.

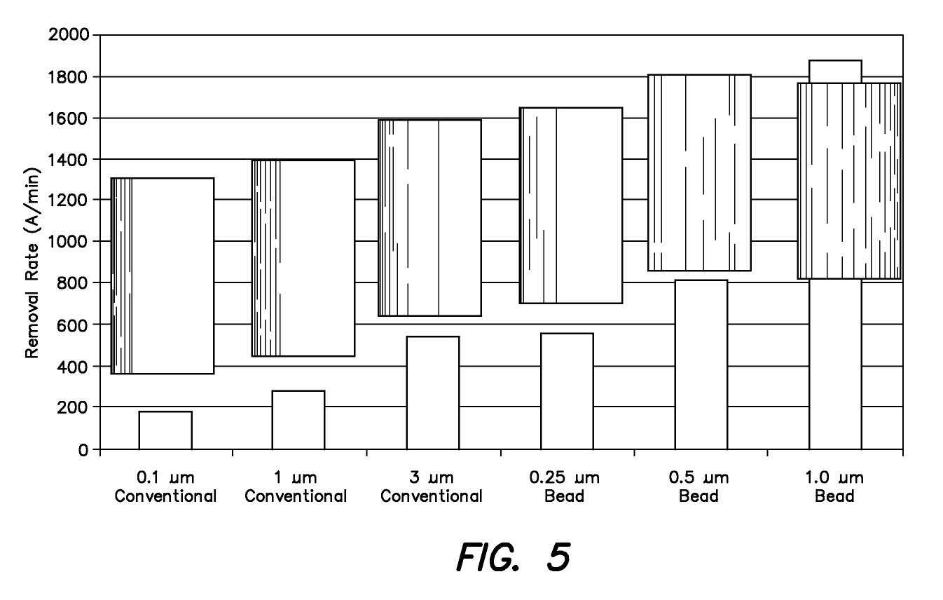

Additionally, the shapes, sizes, and materials used to form the abrasive particles 406 may be varied, depending on different desired process performances. Abrasive particles may have different shapes and sizes. Abrasive particle size affects both the surface finish and polishing rate as described below in reference to FIG. 5. Abrasive shape may also affect the surface finish. For example, a particular particle shape and size may be more suited for an increased removal rate, while a different particle shape and size may be more suited for a particular surface finish. Different abrasive minerals have very different polishing rates on certain films. For example, for a given abrasive particle size and shape on oxide or nitride films, a diamond particle has a much larger polishing rate than an alumina particle.

Another aspect of the invention involves coating methods which can increase the polishing rate without increasing the size of the particles 406. The new coating methods include mixing the abrasive particles 406 with binder material 412 to form individual beads 414 of particles suspended in binder material 412, as loosely depicted in the conceptualized schematic drawing of FIG. 4B. Those individual beads 414 then are affixed to the tape base 410, e.g., a polymer film such as PET. The abrasive beads 414 may be affixed to the tape base 410 such as by being coated in resin layer 408 onto base 410. The abrasive beads 414 may be characterized as being embossed in the resin layer 408. The results of such a coating process include a rougher coating surface and higher contact pressure on the polished surface.

FIG. 5 shows a comparison of the oxide removal rates of differently coated tapes having, on the one hand, a conventional coating of particles applied directly on the resin layer, versus, on the other hand, the novel bead coating. As the graph illustrates, using diamond particles of the same size in the bead coating and the conventional coating, the bead technology has a higher oxide removal rate than does the conventional diamond coating technology, at the same process conditions.

The abrasive bead technology may be used with many polishing systems, polishing parameters, and tape parameters. The abrasive bead technology may be used with abrasive particles of various materials, sizes and shapes. Moreover, the number of abrasive particles per abrasive bead may be varied; more abrasive particles per bead may increase material removal, but may roughen the finish. The number of abrasive beads per square centimeter of abrasive side surface area may be varied also, in accordance with desired polishing outcomes. Different types of binder material and resin material may be employed to adjust for desired polishing parameters. The binder and resin also may have the same or similar compositions. In addition, the abrasive bead technology may be applied not only to polishing tape, but to any polishing device, including polishing pads (such as for polishing a flat surface 102, 102′ of a substrate 100), polishing tips or discs (such as used with angle grinders), and polishing sheets (analogous to sandpaper).

### Resin

The resin layer 408 may be formed from a plurality of different resins depending on the abrasive particles used as well as on the desired durability of the resin. Resin type is a factor affecting the polishing result insofar as a harder resin has, for instance, a larger polishing rate. Numerous resin and binder materials are known in the art, and an explanation of different types appears, for instance, in U.S. Pat. No. 6,165,061, to Fuji et al., titled “ABRASIVE TAPE, PROCESS FOR PRODUCING IT, AND COATING AGENT FOR ABRASIVE TAPE,” which is incorporated by reference herein in its entirety.

### Tape Base

The polishing system 200 as shown in FIGS. 2A, 2B, and 3, for instance, may utilize the polishing tapes 400 on the substrate bevel 112, 114 and notch 116. Due to the curvature of the substrate edge 110 and notch 116 shape as shown in FIG. 1B, close contact of the fixed abrasive tape 400 with the substrate 100 is important for effective material removal. For example, a tape 400 with stiff and/or thick base 410 may be inappropriate in the notch polishing where the shape of the notch 116 is irregular and not smooth. Therefore, the flexibility of the polishing tape 400 may be important so that close contact with the polishing surface may be made by a backing pad 208 behind the polishing tape 400. The use of the thin and/or soft coating tape bases 410 can provide such flexibility. Tape base type may affect the tape hardness, so as with the tape thickness, this factor also affects the polishing result.

### Tape Base Thickness

Tape thickness is important to the invention. Thinner tape is easier to deform to match the wafer edge shape during the polishing. Polishing with thinner tape leads to a different polishing result compared with thick polishing tape. Thinner tape also means more polishing tape can be installed onto the tape cassette of a given cassette size. More tape per cassette means more wafers can be processed without shutting down the tool to refill the tape, i.e., a shorter down time for the tool for maintenance. Shorter down times also lower the overall process cost. The thickness of the tape 400 preferably may range from approximately 0.02 mm to 1 mm. The optimized thickness depends on the strength of the base 410 relative to the coating process, the operated tape tension during polishing, and the integrity of the tape 400 with maximum system operation conditions. The optimized polishing tape thickness preferably is less than approximately 0.06 mm on PET material. In one or more embodiments, the abrasive tape may be about 0.001 to about 0.02 of an inch thick and be able to withstand about 1 to about 8 lbs. of tension. Other tapes having different thicknesses and strengths may be used.

### Tape Base Width

Tape width also is important to the invention in at least two ways. First, a small tape width may mean a low consumable cost. In order to cut down the process cost, the tape width preferably is not too large because the edge of the tape is not effectively used during polishing. Second, tape width is a factor affecting the hardware design. In accordance with the backing pad shape, the polishing tape is deformed during polishing. A wider tape width may require a higher tape tension to avoid unnecessary touches from the tape edge to the wafer surface. The contact area between the polishing tape 400 and the substrate edge 110 and/or notch 116 is determined by the designs of the backing pad 208, which are optimized for polishing efficiency. The width of the polishing tape 400 in the polishing unit is, therefore, determined by those contact areas and preferably ranges from about 28 mm to about 5 mm. The nominal tape width is about 14 mm and can be further reduced for cost reduction. Determining the minimum width is impacted not only by the contact area design, but also by the ability of the system 200 to maintain a consistent tape polishing while monitoring tape slippage. Different widths of tape 400 ranging from about 1 inch to about 1.5 inches may be used as well.

### Polishing Parameters

Polishing parameters may include numerous aspects of the substrate polishing, desired material removal rates, and desired finishes, which are dependent on many factors, as discussed above, including abrasive particle material, size, and shape; resin type; tape base type; tape base thickness and width; tape speed; substrate movement; etc. Additionally, a fluid may also be used to enhance the removal capability of the tape 400 as well as to provide a better surface finish for the edge 104 of the substrate 100 (as seen for example in FIG. 8). The different abrasive particle 406 type, shape and size as well as the type of resin 408 used may vary depending on the fluids used.

In some embodiments, as shown herein, the tape 400 may be manufactured in a roll form to be placed into a bevel polisher, as shown in FIGS. 2A and 2B. However, this is for purposes of example only, and the tape 400 may be manufactured in other forms, including but not limited to strips or pads.

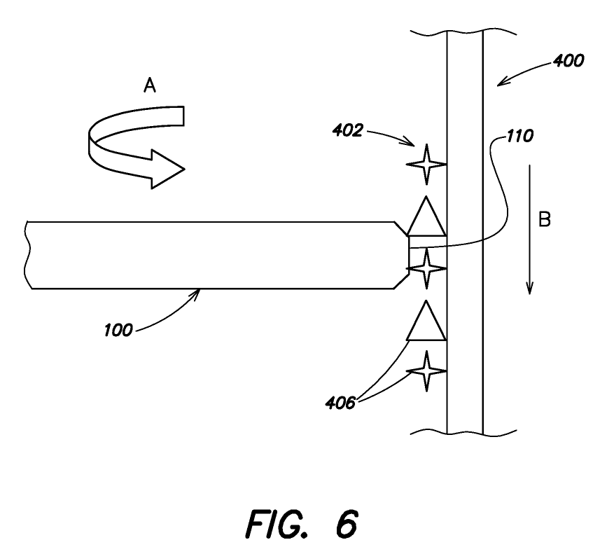

Turning to FIG. 6, a schematic illustration of an example embodiment of the polishing tape 400 polishing the edge 104 of the substrate 100 is depicted. The substrate 100 may rotate in a direction indicated by directional arrow “A.” As the substrate 100 rotates, the polishing tape 400 is able to contact different portions of the edge 104, thereby polishing the entire edge 104 of the substrate 100. At the same time the substrate 100 is rotating, the tape 400 may also be moving in a direction indicated by directional arrow “B.” As the tape 400 moves, fresh or unused abrasive particles 406 are used to polish the edge 104, thereby preventing sub-par polishing by worn abrasive particles 406. A supply spool (shown in FIGS. 2A and 2B) may include unused tape 400 available to be unwound and pulled into position adjacent the substrate 100 while a take-up spool (e.g., shown in FIG. 2A) may be adapted to receive used and/or worn tape 400. One or both spools may be indexed to precisely control the amount of tape 400 that is advanced.

While the abrasive side 402 of the tape 400 is shown in FIG. 6 as contacting only the outer edge 110 of the substrate 100, the tape 400 may have a pre-set measure of thickness to provide flexibility and allow the tape 400 to conform to the entire wafer edge 104, including the bevels 112, 114. The total thickness of the tape 400 is taken into account, as discussed above, and it may be, for instance, less than 10 mm, and preferably less than 2 mm. Other thicknesses may be used.

### Tape Speed

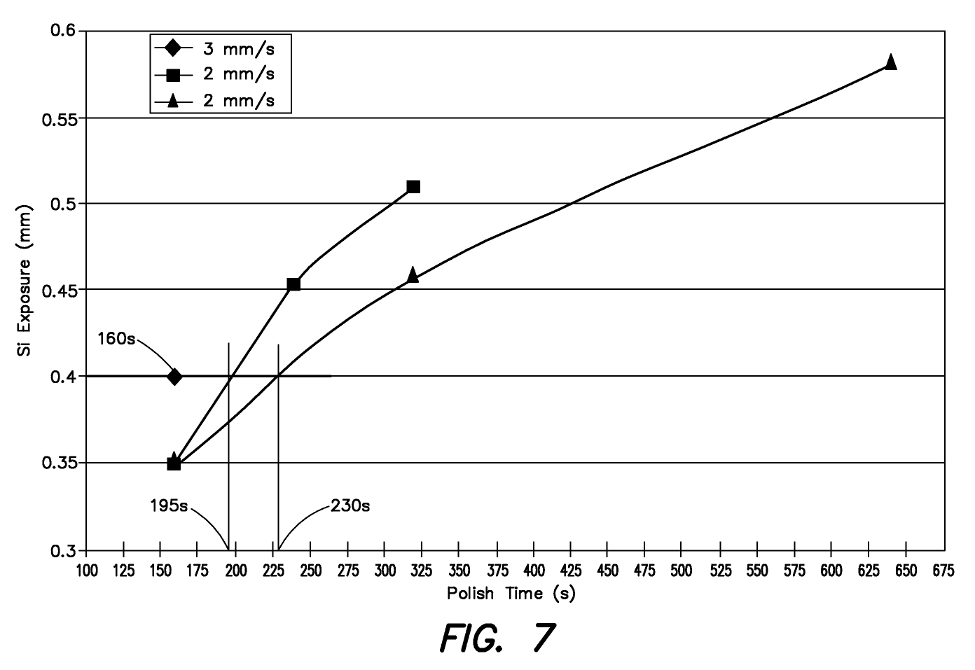

During the polishing process, the polishing tape 400 is set at some tape speed so a fresh abrasive surface 402 of the polishing tape 400 is exposed continuously to provide a consistent removal rate. Tape speed is an adjustable process parameter in the polishing recipe. It has a significant impact on the process result and is important to the invention. A higher tape speed usually leads to a larger polishing rate. That is, a higher tape speed provides a higher materials removal, which uses more tape and results in higher cost of use. However, at the expense of the throughput, a lower tape speed can be used to obtain the same process performance and lower tape usage. Marginal increase in polishing rate may diminish as the tape speed increases, leading to a maximum polishing rate. FIG. 7 shows actual data representing how the tape speed impacts the polishing result (Si exposure distance). FIG. 7 shows the process performance, measured in silicon exposure distance (Si ED) versus the process time at different tapes speed. With the same Si ED of 0.4 mm, the tape usages are 480 mm, 390 mm, and 230 mm for the tape speed of 3 mm/s, 2 mm/s, and 1 mm/s respectively. Preferable system designs can allow the tape speed to vary from 0.01 mm/s to 20 mm/s.

### Polishing System Variations

Turning to FIG. 8A, a schematic plan view of another exemplary edge polishing system 800 is depicted. A frame 802 supports and tensions a polishing tape 804 in a plane perpendicular to the major surfaces 102, 102′ of a substrate 100 such that the edge 104 of the substrate 100 may be pressed against (e.g., as indicated by the straight downward arrows 805a, 805b) an abrasive side 806 of the polishing tape 804 and the polishing tape 804 may contour to the substrate edge 104. In other words, the frame 802 simply may rely on the tension of the tape 804 to provide lateral pressure to the substrate edge 104. As indicated by the curved arrow 805c, the substrate 100 may be rotated against the polishing tape 804. In some embodiments, the polishing tape 804 may be supported by a pad 808 disposed adjacent a smooth side (e.g., a non-abrasive side) of the polishing tape 804 and mounted on the frame 802. As indicated by the straight upward pointing arrow 807, the frame 802 including the tensioned polishing tape 804 and/or the pad 808 may be pushed against the edge 104 of the substrate 100.

Additionally or alternatively, an additional length of the polishing tape 804 may be supported and tensioned by spools 810, 812 mounted to the frame 802. A supply spool 810 may include unused polishing tape 804 available to be unwound and pulled into position adjacent the substrate 100 while a take-up spool 812 may be adapted to receive used and/or worn polishing tape 804. One or both of the spools 810, 812 may be indexed to precisely control the amount of polishing tape 804 that is advanced. The spools 810, 812 may include a tensioning capability to allow the polishing tape 804 to be stretched taught and to apply pressure to the substrate edge 104. The spools 810, 812 preferably may be between approximately 1 inch and 4 inches in diameter, preferably may hold between about 500 inches and 10000 inches of tape 804, and preferably may be constructed from any practicable materials such as polyurethane, polyvinyl difloride (PFDF), etc. Other materials may be used. The frame 802 may be constructed from any practicable materials such as aluminum, stainless steel, etc.

The length of tape 804 may be disposed orthogonal to the edge 104 of a substrate 100 being polished. Alternatively the longitudinal direction of the tape 804 may be aligned with the edge 104 of a substrate 100 being polished. Additionally, other tape orientations and configurations may be employed. For example, the tape 804 may be held diagonally relative to the major surface 102 of the substrate 100. Essentially, the tape 804 is brought into contact with the bevels 112, 114, and outer edge 110 of a substrate 100 without contacting the device region 106 of the substrate 100. In operation, this is achieved by angularly translating a head or frame (and consequently, a portion of tape in contact with and contoured to the edge 104 of a substrate 100) around an axis that is tangential to the outer edge 110 of the substrate 100 as it is rotated.

Further, the tape 804 may be mounted in a continuous loop and/or the tape 804 may be continuously (or intermittently) advanced to polish and/or increase the polishing effect on the substrate edge 104. For example, the advancement of the tape 804 may be used to create and/or enhance the polishing motion. In some embodiments, the tape 804 may be oscillated back and forth to polish and/or enhance the polishing effect on a stationary or rotating substrate 100. In some embodiments, the tape 804 may be held stationary during polishing. Further, the tape 804 tension and or force may be varied based on various factors including, for example, the angle and/or position of the tape 804, the polishing time, the materials used in the substrate, the layer being polished, the amount of material removed, the speed at which the substrate is being rotated, the amount of current being drawn by the driver rotating the substrate, etc.

In some embodiments, one or more fluid channels 814 (e.g., a spray nozzle or bar) may be provided to deliver chemicals and/or water to aid in the polishing/cleaning of the substrate edge 104, lubricate the substrate, and/or to wash away removed material. For instance, a CMP-style chemical slurry may be applied to an embossed fixed abrasive tape to provide further abrasive or corrosive effects.

Referring to FIG. 8B, removal rates of three edge polishing processes are compared graphically. The three processes, listed in order of effectiveness, include: process 816A, an embossed fixed abrasive tape with a CMP-style chemical slurry, in accordance with an embodiment of the present invention (plotted with squares); process 816B, a diamond particle tape with deionized water (plotted with triangles); and process 816C, a ceria oxide lapping pad with a chemical slurry (plotted with ovals). The inventive tape and chemical process 816A according to an embodiment of the present invention used CMP-style pad materials in a roll form, and it clearly demonstrated oxide removal rates higher than those of the diamond tape with deionized water process 816B. The removal rate of process 816A starts off at around 6000 angstroms and increases to a maximum removal rate of around 8700 angstroms before dropping off. In contrast, process 816B starts off with a removal rate of about 2400 angstroms and peaks at around 2600 angstroms. The CeO lapping pad with chemicals process 816C appeared to be only minimally effective.

Moreover, as represented in FIG. 8C, the surface finish 818A achieved by the inventive embodiment 816A of FIG. 8B was much better than the surface finish 818B of FIG. 8D achieved by the diamond tape process 816B of FIG. 8B. With a good enough finish after only a single polishing process, there may not be a need for a buffing process thereafter. Thus, polishing the edge in accordance with the present invention may achieve a surface finish that is suitable for advancement in the fabrication process and not in need of buffing.

The fluid channel 814 may be adapted to deliver fluid to the substrate 100, to the polishing tape 804, and/or to the pad 808. The fluids may include deionized water, a surfactant and/or other known cleaning chemistries. In some embodiments, sonic (e.g., megasonic) nozzles may be used to deliver sonicated fluids to the substrate edge 104 to supplement the cleaning. Fluid also may be delivered through the polishing tape 804 and/or pad 808 to the edge 104. The various fluids may be selectively delivered under the direction of a controller (not shown), and may be for use in polishing, lubricating, particle removal/rinsing, and/or inflating a bladder within the pad 808. For example, in some embodiments, the same fluid delivered through the permeable pad 808 may be used for both polishing and inflating the pad 808 while a different fluid, delivered to the same substrate 100 via a second channel (not shown) is used for rinsing and lubricating.

Any combination of the above described polishing motions and/or methods that are practicable may be employed. These methods provide additional control over the edge polish process that can be used to compensate for geometry and changes in the material being removed as the tape 804 is rotated or moved about or relative to the edge 104.

### Polishing Methods

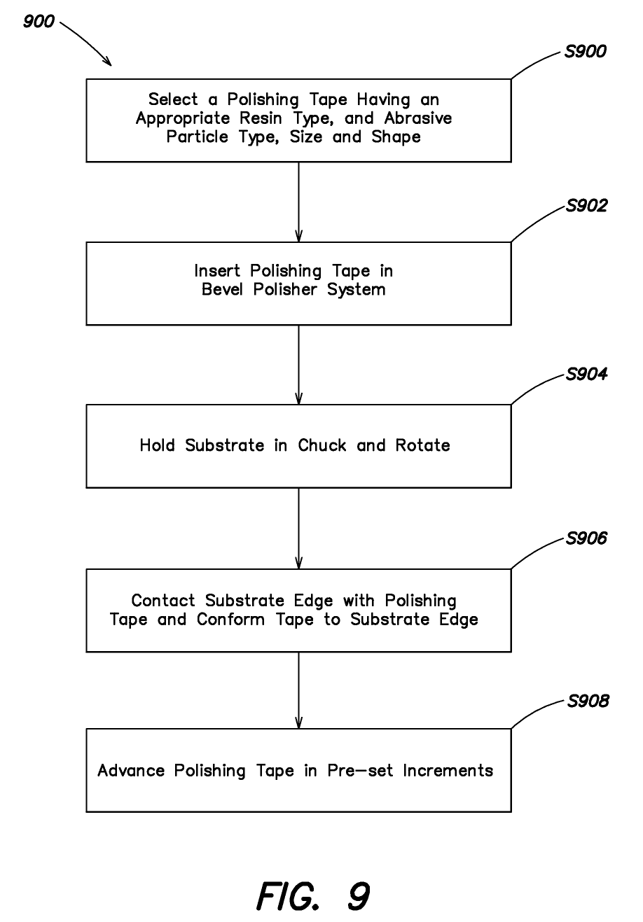

FIG. 9 is a flowchart of exemplary optional polishing steps, one or more of which may be combined to create a method embodiment 900 of the polishing of the edge of a substrate. In step S900, a polishing tape is selected. The polishing tape may be selected from a plurality of rolls of tape, each having a resin type and abrasive particle type (including material, size and shape) suited to a particular task, such as increasing a removal rate or enhancing a surface finish. The roll of polishing tape is inserted into a bevel polishing system in step S902. In some systems, as described above, the polishing tape may be tensioned between two spools, namely, a supply spool and a take-up spool.

In step S904, a substrate is held by a vacuum chuck and rotated. The polishing tape contacts and conforms to the edge of the substrate in step S906. As shown in FIG. 8A, a chemical slurry optionally may be applied to bevel area while the polishing tape contacts and conforms to the edge of the substrate. In step S908, the polishing tape is advanced in pre-set increments. After cleaning one or more substrates, the portion of the polishing tape employed for such cleaning may become worn. Therefore, the take-up reel may be driven to draw the polishing tape by a fixed amount from the supply reel toward the take-up reel. In this manner, an unused portion of the polishing tape may be provided between the take-up reel and supply reel. The unused portion of the polishing tape may be employed to subsequently clean one or more other substrates in a manner similar to that described above. Consequently, a worn portion of polishing tape may be replaced with an unused portion with little or no impact on substrate processing throughput.

It should be understood that the inventive edge polishing apparatus and methods described herein may be employed in apparatus other than those adapted for bevel and edge polishing and/or removal of films on substrates. Further, as will be apparent to those of ordinary skill in the art, the apparatus and methods described herein may be employed to polish and/or remove films on an edge of a substrate supported in any orientation (e.g., horizontal, vertical, diagonal, etc).

Further, it should be understood that although only examples of cleaning a round substrate are disclosed, the present invention could be modified to clean substrates having other shapes (e.g., a glass or polymer plate for flat panel displays). Further, although processing of a single substrate by the apparatus is shown above, in some embodiments, the apparatus may process a plurality of substrates concurrently.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

The invention claimed includes:

1. An apparatus adapted to polish a substrate comprising:
a polishing device, the polishing device comprising:
a base having a first surface;
a resin layer adhering to the first surface of the base; and
a plurality of abrasive beads affixed to the first surface by the resin layer, the plurality of abrasive beads comprising a plurality of abrasive particles suspended in binder material;
wherein the plurality of abrasive beads and the resin layer comprise an abrasive side of the polishing device adapted to contact the substrate.

2. The apparatus of claim 1, wherein the polishing device includes at least one of a polishing tape, a polishing pad, and a polishing tip.

3. The apparatus of claim 1, wherein the plurality of abrasive particles comprises mineral particles including at least one of ceria, silica and diamonds.

4. An apparatus adapted to polish the edge of a substrate comprising:
a polishing tape, the polishing tape comprising:
a tape base having a first surface and a second surface;
a resin layer adhering to the first surface of the tape base; and
a plurality of abrasive beads affixed to the first surface by the resin layer, the plurality of abrasive beads comprising a plurality of abrasive particles suspended in binder material;
wherein the plurality of abrasive beads and the resin layer comprise an abrasive side of the polishing tape adapted to contact the edge of the substrate.

5. The apparatus of claim 4, wherein the plurality of abrasive particles comprises mineral particles including at least one of ceria, silica and diamonds.

6. A method for forming a polishing device adapted to polish a target surface, the method comprising:
forming a plurality of abrasive beads comprising a plurality of abrasive particles suspended in binder material; and,
affixing the plurality of abrasive beads by a resin layer to a first surface of a device base;
wherein the plurality of abrasive beads and the resin layer comprise an abrasive side of the polishing device adapted to contact the target surface.

7. The method of claim 6, wherein the polishing device comprises a polishing tape adapted to polish an edge of a substrate.

8. A method for polishing an edge of a substrate, the method comprising:
holding a substrate with a holding device located away from a edge of the substrate;
rotating the substrate by rotating the holding device;
applying a polishing tape to the edge while the substrate is rotating; and
advancing the polishing tape while the polishing tape is being applied to the edge;
wherein the polishing tape is the only apparatus that contacts the edge while the substrate is rotating.

9. The method of claim 8, further comprising:
applying a chemical slurry to the edge while the substrate is rotating, the chemical slurry having an abrasive or corrosive effect on the edge.

10. The method of claim 8, wherein the polishing tape comprises:
a tape base having a first surface and a second surface;
a resin layer adhering to the first surface of the tape base; and
a plurality of abrasive beads affixed to the first surface by the resin layer, the plurality of abrasive beads comprising a plurality of abrasive particles suspended in binder material;
wherein the plurality of abrasive beads and the resin layer comprise an abrasive side of the polishing tape adapted to contact the edge of the substrate.

11. The method of claim 10, further comprising:
applying a chemical slurry to the edge while the substrate is rotating, the chemical slurry having an abrasive or corrosive effect on the edge.

12. The method of claim 8, wherein the polishing tape comprises:
a tape base having a first surface and a second surface;
a resin layer adhering to the first surface of the tape base; and
a plurality of embossed abrasive particles affixed to the first surface by the resin layer;
wherein the plurality of embossed abrasive particles and the resin layer comprise an abrasive side of the polishing tape adapted to contact the edge of the substrate.

13. The method of claim 12, further comprising:
applying a chemical slurry to the edge while the substrate is rotating, the chemical slurry having an abrasive or corrosive effect on the edge.

14. The method of claim 13, wherein polishing the edge achieves a maximum removal rate of at least 6000 angstroms.

15. The method of claim 13, wherein polishing the edge achieves a suitable surface finish not in need of buffing.

16. The method of claim 8, wherein the plurality of abrasive particles comprises mineral particles of ceria, silica and diamonds.

17. The method of claim 8, wherein the polishing tape comprises a first polishing tape for a first purpose and a second polishing tape for a second purpose; and wherein applying the polishing tape to the edge while the substrate is rotating comprises:
applying the first polishing tape to the edge while the substrate is rotating; and
applying the second polishing tape to the edge while the substrate is rotating.

18. The method of claim 17, wherein the first polishing tape is applied by a first polishing apparatus, the second polishing tape is applied by a second apparatus, the first purpose differs from the second purpose, and the first polishing apparatus is distinct from the second polishing apparatus.

19. A method for forming a polishing tape adapted to polish an edge of a substrate, the method comprising:
affixing a plurality of embossed abrasive particles by a resin layer to a first surface of a tape base;
wherein the plurality of embossed abrasive particles and the resin layer comprise an abrasive side of the polishing tape adapted to contact the edge of the substrate;
wherein the abrasive side is compatible with a chemical slurry for use in polishing the edge of the substrate; and
wherein the chemical slurry has an abrasive or corrosive effect on the edge of the substrate.

20. The method of claim 19, wherein the plurality of embossed abrasive particles are partially raised above a top surface of the resin and partially sunken in the resin layer.
